(19) United States
(12) Patent Application Publication
(10) Pub. No.: US 2014/0080226 A1
(43) Pub. Date: Mar. 20, 2014

(54) FLUID TRANSPORT SYSTEM WITH GASKET

(71) Applicant: Bio-Rad Laboratories, Inc., Hercules, CA (US)

(72) Inventors: Thomas H. Cauley, III, Pleasanton, CA (US); Steven Romine, Vacaville, CA (US)

(73) Assignee: Bio-Rad Laboratories, Inc., Hercules, CA (US)

(21) Appl. No.: 14/032,149

(22) Filed: Sep. 19, 2013

Related U.S. Application Data
(60) Provisional application No. 61/703,200, filed on Sep. 19, 2012.

(51) Int. Cl. B01L 3/00

(52) U.S. Cl. CPC B01L 3/502715
USPC 436/180; 422/505

(57) ABSTRACT

Fluid transport system, including methods and apparatus, for moving fluid. The system may include a plurality of wells each having a rim. The system also may include a gasket defining a plurality of apertures that extend through the gasket from a top side to a bottom side of the gasket. The bottom side may define a plurality of grooves, with each groove extending at least partway around an axis defined by an aperture of the plurality of apertures. The gasket may be configured to have the top side of the gasket engaged with a pump assembly and at least a portion of the rim of each of the wells disposed in at least one groove of the plurality of grooves, to provide sealed communication between the pump assembly and each of the wells.

### CROSS-REFERENCE TO PRIORITY APPLICATION

This application is based upon and claims the benefit under 35 U.S.C. §119(e) of U.S. Provisional Patent Application Ser. No. 61/703,200, filed Sep. 19, 2012, which is incorporated herein by reference in its entirety for all purposes.

### CROSS-REFERENCES TO OTHER MATERIALS

This application incorporates by reference in their entireties for all purposes the following patent documents: U.S. Patent Application Publication No. 2010/0173394 A1, published Jul. 8, 2010; U.S. Patent Application Publication No. 2012/0152369 A1, published Jun. 21, 2012; and U.S. Patent Application Publication No. 2012/0190032 A1, published Jul. 26, 2012.

### INTRODUCTION

Microfluidic devices generally have micro-scale channels that hold and direct fluid for mixing, processing, reaction, detection, and so on. Each device may have larger ports, such as wells, that communicate with the channels. The wells allow fluid to be introduced into and removed from the device. For example, pressure/suction can be applied to wells of the device with an external pump, to drive fluid into, along, and/or out of the channels. In some cases, the pressure/suction may be applied in parallel to wells of the device, such as to form a set of emulsions. However, forming a reliable seal between the pump and each of the wells can be problematic. An improved system is needed for application of pressure and/or suction to a set of wells of a microfluidic device, to move fluid into and/or out of the wells.

### SUMMARY

The present disclosure provides a fluid transport system, including methods and apparatus, for moving fluid. The system may include a plurality of wells each having a rim. The system also may include a gasket defining a plurality of apertures that extend through the gasket from a top side to a bottom side of the gasket. The bottom side may define a plurality of grooves, with each groove extending at least partway around an axis defined by an aperture of the plurality of apertures. The gasket may be configured to have the top side of the gasket engaged with a pump assembly and at least a portion of the rim of each of the wells disposed in at least one groove of the plurality of grooves, to provide sealed communication between the pump assembly and each of the wells.

### BRIEF DESCRIPTION OF THE DRAWINGS

FIG. 1 is an exploded isometric view, in partially schematic form, of an exemplary fluid transport system including a multi-well container to form a set of emulsions, a gasket to engage a top portion of a row of wells of the container, and a pump assembly including a pump connected to a gasket-contacting manifold, in accordance with aspects of the present disclosure.

FIG. 2 is a bottom view of an upper component of the multi-well container of FIG. 1, taken in the absence of a floor layer of the container, and showing a series of emulsion formation units created by wells and channels of the container, in accordance with aspects of the present disclosure.

FIG. 3 is a fragmentary, bottom plan view of the upper component of FIG. 2, taken generally at the region at “3” in FIG. 2 around one of the emulsion formation units.

FIG. 4 is a fragmentary sectional view of the fluid transport system of FIG. 1 in an assembled, operative configuration, taken generally along line 4-4 of FIG. 1 during formation of emulsions, with fluid transport driven by suction applied to a row of wells by the pump assembly, in accordance with aspects of the present disclosure.

FIG. 5 is a sectional view of the fluid transport system of FIG. 1, taken generally along line 5-5 of FIG. 4 without the manifold.

FIG. 6 is a bottom plan view of the gasket of FIG. 1.

FIG. 7 is a bottom plan view of another exemplary gasket for the fluid transport system of FIG. 1, in accordance with aspects of the present disclosure.

FIG. 8 is a bottom fragmentary view of the gasket of FIG. 7, showing one of the sealing members of the gasket.

FIG. 9 is a sectional view of the gasket of FIG. 7, taken generally along line 9-9 of FIG. 7, with the gasket assembled with the multi-well container of FIG. 1, and with an emulsion present in the well that is shown.

FIG. 10 is a sectional view of the gasket and multi-well container of FIG. 9, taken as in FIG. 9 with a fluid transfer tip extending through a slit defined by the gasket and being used to draw a portion of the emulsion into the tip through an open end thereof.

FIG. 11 is a fragmentary sectional view of an exemplary fluid transport system including a manifold defining a series of recesses that align with and at least partially receive a corresponding series of ridges formed on a top side of the gasket, in accordance with aspects of the present disclosure.

FIG. 12 is a fragmentary sectional view of another exemplary fluid transport system including a manifold defining a series of recesses that align with a corresponding series of ridges formed on a top side of the gasket, in accordance with aspects of the present disclosure.

FIG. 13 is a fragmentary sectional view of yet another exemplary fluid transport system including yet another exemplary gasket, with the view taken transverse to the long axis of the gasket, in accordance with aspects of the present disclosure.

FIG. 14 is a fragmentary sectional view of the fluid transport system of FIG. 13, taken generally along line 14-14 of FIG. 13.

### DETAILED DESCRIPTION

The present disclosure provides a fluid transport system, including methods and apparatus, for moving fluid. The system may include a plurality of wells each having a rim. The system also may include a gasket defining a plurality of apertures that extend through the gasket from a top side to a bottom side of the gasket. The bottom side may define a plurality of grooves, with each groove extending at least partway around an axis defined by an aperture of the plurality of apertures. The gasket may be configured to have the top side of the gasket engaged with a pump assembly and at least a portion of the rim of each of the wells disposed in at least one groove of the plurality of grooves, to provide sealed communication between the pump assembly and each of the wells.

The present disclosure may provide a system, including methods and apparatus, for the production of emulsions in parallel. In some embodiments, the system may include a multi-well container, interchangeably termed a microfluidic device or chip, having a plurality of emulsion formation units formed integrally and each capable of forming droplets serially. Each emulsion formation unit may include an input well for holding an oil phase, another input well for holding an aqueous phase, and an output well to collect an emulsion formed from the contents of the input wells. The system also may include a pump assembly that is operatively connectable to the container to drive formation of emulsions. The pump assembly may apply pressure or suction (e.g., applied pneumatically) to wells of the container to drive flow of fluid from the input wells to the output well of each emulsion formation unit. The system further may include a gasket that forms a seal between wells of the container and the pump assembly, particularly a manifold thereof.

Further aspects of the present disclosure are presented in the following sections: (I) exemplary fluid transport system, and (II) examples.

### I. Exemplary Fluid Transport System

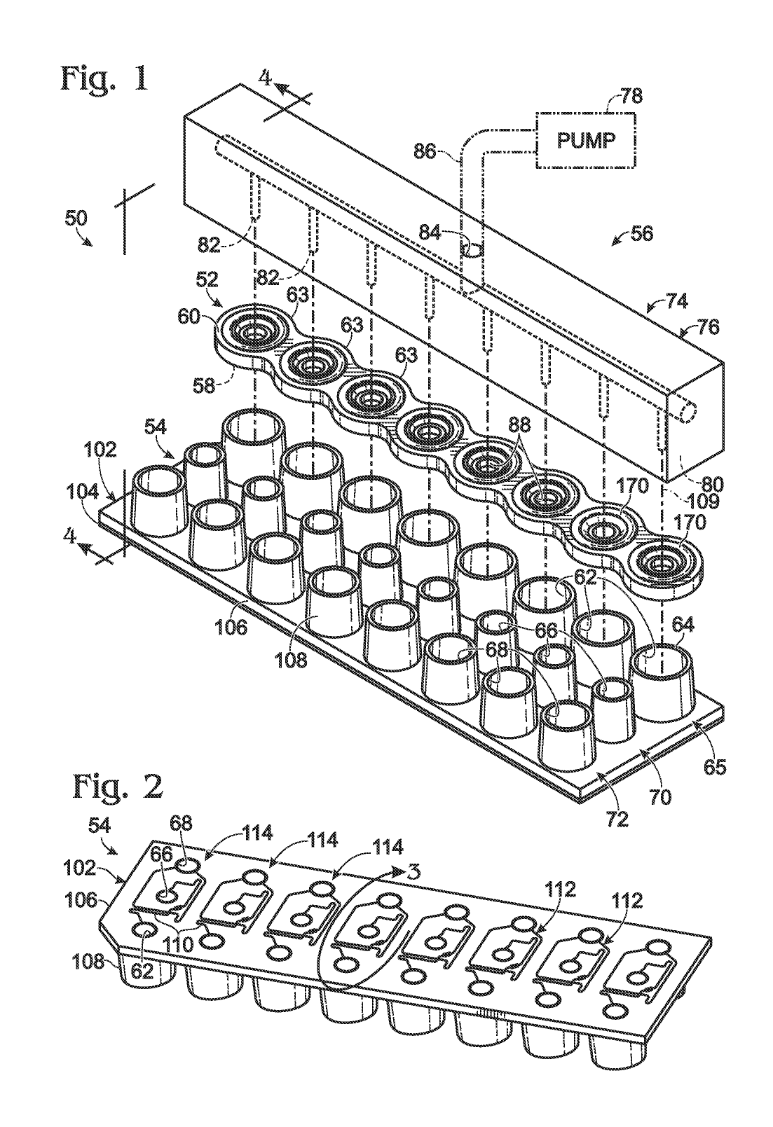

This section describes an exemplary fluid transport system 50; see FIGS. 1-6.

FIG. 1 shows an exploded view of fluid transport system 50. The system may include a gasket 52 that provides sealed communication between a multi-well container 54 and a pump assembly 56.

The gasket may have a bottom side 58 (interchangeably termed a lower surface region) opposite a top side 60 (interchangeably termed an upper surface region). Bottom side 58 may be configured to contact a plurality of wells 62 of container 54. Top side 60 may be configured to contact pump assembly 56.

The gasket may include a plurality of sealing members 63 formed integrally. Each sealing member 63 may contact a single well 62 of container 54 and may be configured to place the single well in sealed communication with pump assembly 56. Sealing members 63 of the gasket may be copies of one another. The sealing members may be arranged in any suitable array, such as a linear array (as shown here), a two dimensional array (e.g., composed of two or more linear arrays that are not collinear (e.g., parallel to one another and aligned or staggered)), or the like. In some examples, one or more of the sealing members may be configured to be detachable from the remainder of the sealing members, such as by tearing, breaking, or cutting the gasket. Accordingly, the gasket may define a prospective region of detachment as a thinner and/or weakened (e.g., perforated) region of the gasket.

When system 50 is operatively assembled, gasket 52 may be sandwiched between wells 62 and pump assembly 56, optionally with container 54 and pump assembly 56 applying compressive force to the gasket such that the gasket is squeezed between the container and the pump assembly. Pump assembly 56 then may be operated to create a pressure differential, generally by applying suction (interchangeably termed negative pressure) and/or pressure (interchangeably termed positive pressure) that moves fluid into and/or out of wells 62, as described in more detail below.

The gasket may engage and/or at least partially cover any suitable wells of the multi-well container. For example, the gasket may engage only input wells, only output wells, or both input wells and output wells. The gasket may form a circumferential seal near and/or at a top surface region 64 (interchangeably termed a rim) of each engaged well and may provide sealed communication between the pump assembly and the engaged well at the gasket. Each sealing member 63 may separately seal one of wells 62 to pump assembly 56.

Gasket 52 may be configured to contact only a subset of the wells of container 54 (e.g., a minority or majority of the wells) or all of the wells. For example, gasket 52 may contact and substantially cover a first plurality or set of wells (e.g., a first row 65 of output wells 62), but may not contact and/or substantially cover a second plurality or set of wells, such as input wells 66 and 68 of second and third rows 70 and 72, respectively. In other embodiments, the gasket may contact and/or substantially cover a majority of the wells, such as rows 70 and 72 of input wells 66 and 68 (and not row 65 of output wells 62) or each of rows 64, 70, and 72 (i.e., both input wells and output wells).

Pump assembly 56 may include an interface member 74, such as a manifold 76, operatively connected to a pump 78. The interface member may have a gasket-contacting side 80 (interchangeably termed a gasket-contacting surface or surface region) to engage gasket 52. Side 80 may define a plurality of openings 82 that are configured to be aligned with wells 62 of container 54 and/or sealing members 63 of gasket 52. Each opening 82 may be connected or connectable to pump 78, such that the pump can generate a pressure differential at each opening, optionally in parallel. In the depicted embodiment, openings 82 all communicate with the same port 84 of manifold 76, to allow pump 78 to be operatively connected to openings 82 in parallel via a single conduit 86.

Gasket-contacting side 80 may be formed by a lower surface region of interface member 74. The gasket-contacting side may face downward and may be planar. In some cases, the gasket-contacting side may define one or more recesses to receive and/or contact at least a portion of the gasket and/or may define one or more projections to contact the gasket (e.g., see Example 2).

Each sealing member 63 of gasket 52 may define one or more apertures 88 for alignment with each well 62 of container 54. Each aperture 88 may be a through-hole that extends from bottom side 58 to top side 60 and may provide communication between the pump assembly and the well. The aperture may align with an opening 82 of interface member 74. In other words, apertures 88 of the gasket may form an array that corresponds in arrangement and spacing to that of wells 62 and openings 82. The gasket of FIG. 1 has a single through-hole defined by each sealing member 63, for each corresponding output well 62 of container 54. The single through-hole allows for fluid communication with the well and may be large enough to allow an end of a pipette tip (or other fluid transfer tip) to pass through the gasket and reach the bottom of the well. The tip may be used for withdrawal of droplets/emulsion from the output well (and/or introduction of fluid into the well) without removing the gasket from its engagement with the well (and, optionally, without temporarily or permanently changing the shape of the through-hole).

In some cases, the gasket may define a slit for each engaged well. The slit may be resiliently expandable to permit insertion of the end of a fluid transfer tip through the slit, and may contract resiliently to a less expanded (more closed) configuration when the tip is removed from the slit. The slit may or may not be sealed against fluid flow when in the closed configuration.

In some cases, the gasket may have protrusions formed on the underside of the gasket. The protrusions may be configured to be received in wells or between wells, to facilitate mating the gasket with the wells, promote alignment, resist slippage of the gasket, and/or attach the gasket to the wells. Further aspects of gasket apertures and protrusions are described below and in Section II.

FIGS. 1-3 show further exemplary aspects of container 54. The container may include an upper portion 102 (which interchangeably may be described as an upper component and/or a molded component) attached to a lower portion 104 (which interchangeably may be described as a floor member or cover layer). The upper portion may form a base 106 of the container and a side wall 108 of each of wells 62, 66, and 68 (see FIGS. 1 and 2). Lower portion 104 may cover (from below) and seal the underside of upper portion 102, and particularly the openings defined by the bottom surface region of upper portion 102, to form a floor region of each well and channel. The lower portion may be formed by a sheet, such as a film, that covers a majority of the bottom surface region of upper portion 104 and openings thereof.

Side wall 108, interchangeably termed a side wall structure, may surround an axis 109 defined by the well (e.g., a central vertical axis) (see FIG. 1). The side wall may bound the well laterally and form rim 64 at the top of the well. The side wall may form an inside wall region (inside the well) and an outside wall region (outside the well). In the present disclosure, rim 64 may be considered as distinct from the inside and outside wall regions. The side wall may have any suitable shape in cross section, orthogonal to axis 109, such as circular, elliptical, rectangular, or the like.

FIGS. 2 and 3 show container 54 positioned upside down in the absence of floor member 104. The container may define a plurality of channels 110 that extend between wells 62, 66, and 68. More particularly, the channels may be formed as isolated channel sets 112, with each set connecting one well 62, one well 66, and at least one well 68, to create an emulsion formation unit 114. Each unit 114 may include at least one well 68 to hold a prospective continuous phase (e.g., an oil phase (or an aqueous phase)), a well 66 to hold a prospective dispersed phase (e.g., an aqueous dispersed phase (or an oil dispersed phase)), and a well 62 to receive and hold an emulsion formed from the continuous and dispersed phases. Each channel set 112 may form a droplet generation site 116, which may, for example, be a channel intersection (see FIG. 3). In the depicted embodiment, a pair of input channels 118a and 118b extend from well 68 and a single input channel 120 from well 66, for intersection at droplet generation site 116, and an output channel 122 extends from the droplet generation site 116 to well 62. Accordingly, each well 62, 66, and 68 may have one or more ports 124 through which fluid may enter or exit the well via at least one of the channels. Each port may be separate from the mouth of the well defined at the top of the well. The port may be spaced from the rim of the well, such as positioned elevationally below the rim (e.g., adjacent the bottom of the well). The port may be formed at a junction between the well and at least one of the channels. Further aspects of structure that may be suitable for container 54 are described in the patent documents listed above under Cross-References, which are incorporated herein by reference, particularly U.S. Patent Application Publication No. 2010/0173394 A1, published Jul. 8, 2010; U.S. Patent Application Publication No. 2012/0152369 A1, published Jun. 21, 2012; and U.S. Patent Application Publication No. 2012/0190032 A1, published Jul. 26, 2012.

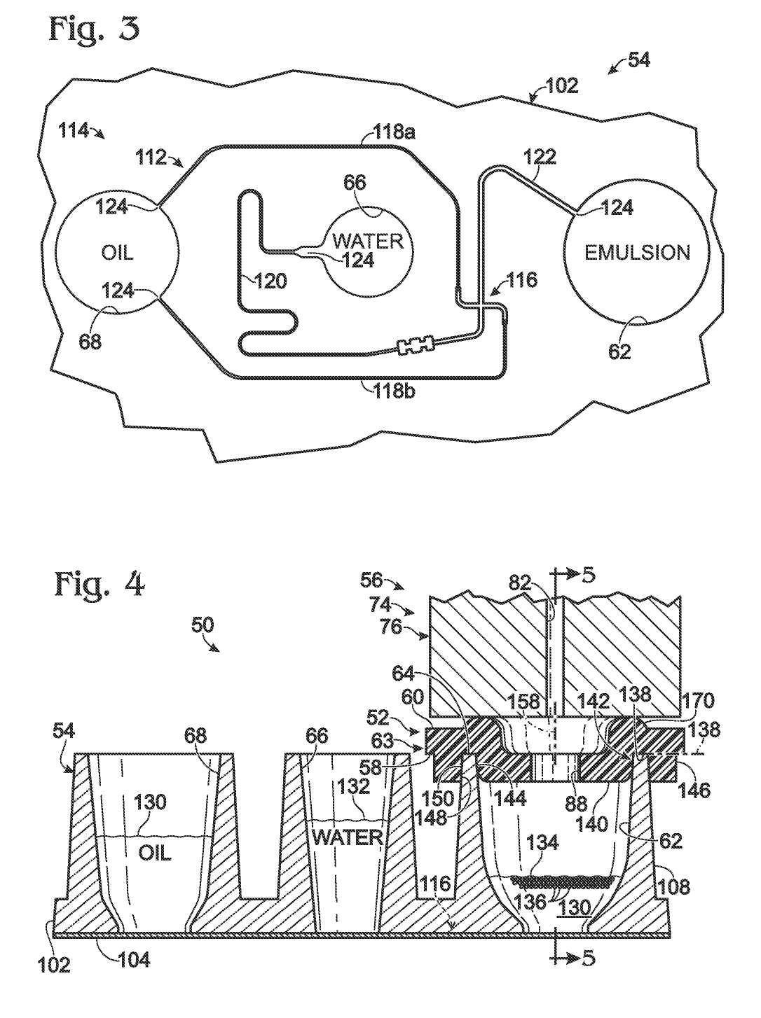

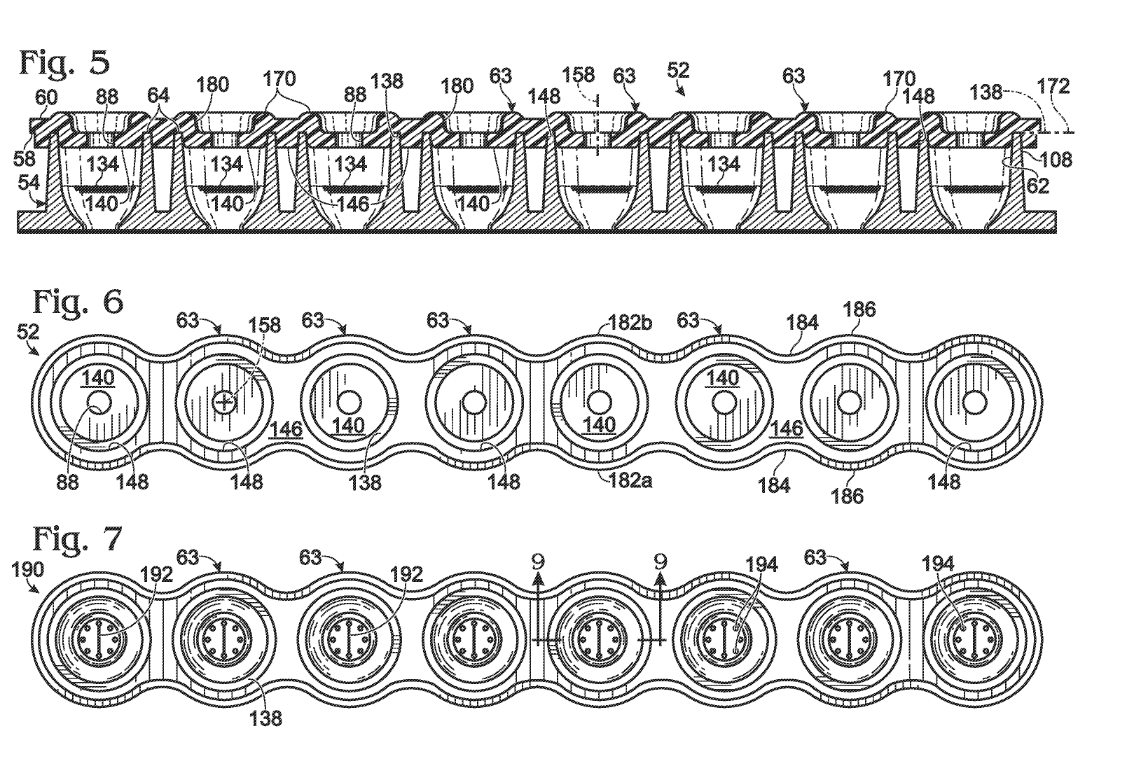

FIG. 4 shows fluid transport system 50 in an assembled, operative configuration, during emulsion formation and collection driven by suction applied to row 65 of output wells 62 by pump assembly 56 (also see FIG. 1). Each input well 68 may contain a prospective continuous phase 130, each input well 66 may contain a prospective dispersed phase 132, and each output well 62 may contain at least a portion of an emulsion 134 formed with phases 130 and 132 at a droplet generation site 116. In the depicted embodiment, emulsion 134 includes droplets 136 that float in continuous phase 130. By placing a dispersed phase 132 in each input well 66 and a continuous phase 130 in each input well 68, an emulsion 134 may be collected in each output well 62 by application of suction (also see FIG. 5). In other embodiments, gasket 52 may be configured to engage input wells 66 and 68, and emulsion formation may be driven by application of pressure to input wells 66 and 68.

Gasket 52 may have surface features defined by bottom side 58 and/or top side 60 that improve performance of the gasket, such as to facilitate alignment and/or engagement/sealing of the gasket with wells 62 and/or interface member 74, and/or disengagement therefrom. The surface features may include one or more recesses, one or more protrusions, or both, which may be defined by the gasket and/or each sealing member 63 of the gasket.

FIGS. 4-6 show features defined by bottom side 58 of the gasket. The bottom side may define one or more protrusions configured to be disposed below a plane 138 defined collectively by rims 64 of wells 62, with each protrusion disposed at least partially inside a well 62 or outside of the wells.

Each protrusion may engage a single well or a plurality of wells. In some cases, a plurality of distinct protrusions formed on the bottom side of the gasket may engage the same well. Each protrusion may engage an inner wall region or an outer wall region of side wall 108 of the well. The protrusion (or a plurality of protrusions) may promote sealing the gasket to the well, may help to hold the gasket in place on the well (e.g., to align the gasket with a well and/or attach the gasket to the well), or both. In some embodiments, one or more protrusions of the gasket may engage the inner wall region of the well and one or more protrusions of the gasket may engage the outer wall region of the same well (for each of wells 62). For example, a protrusion may form a complete (or incomplete) ring that engages the inner wall region of the well, a protrusion may form a complete (or incomplete) ring that engages the outer wall region of the well, or both. Alternatively, or in addition, a plurality of protrusions (e.g., finger-like protrusions) may engage the inner wall region of a well at a plurality of spaced positions (e.g., as an incomplete ring or segmented ring), a plurality of protrusions may engage the outer wall region of the well at a plurality of spaced positions (e.g., as an incomplete ring or segmented ring), or both. In some embodiments, the gasket may form a sealing surface region or ring 138 that engages rim 64 circumferentially, for each of wells 62. Sealing surface region 138 may be flat (planar) and/or the top surface region of the well formed by rim 64 may be flat (planar). As described below, one or more protrusions may replace, facilitate, and/or supplement the sealing function provided by sealing surface region 138, and/or the one or more protrusions may function only for alignment and/or to hold the gasket in place on the well.

Bottom side 58 may define a plurality of protrusions 140 (interchangeably termed plug members) configured to be received in wells 62 of container 54. A distinct plug member 140 may be defined by each sealing member 63 of the gasket, such that each well 62 receives a plug member when the gasket is mated with wells 62. The plug member may be sized and shaped according to a mouth region 142 of the well, such that each plug member aligns a sealing member 63 with a corresponding well 62. The plug member, when received by one of wells 62, may frictionally engage an inside wall region 144 of the well below rim 64. The plug member may provide circumferential contact with and/or may form a circumferential seal with the inside wall region. Bottom side 58 also or alternatively may define one or more protrusions 146 configured to be disposed, at least partially, between wells 62 of the container (and below plane 138), and particularly between rims 64 of adjacent pairs of wells. In the depicted embodiments, a single protrusion 146 extends between each adjacent pair of wells 62 and around the rim of each well 62. In other embodiments, bottom side 58 of the gasket may define a plurality of spaced protrusions arranged along the gasket and configured to be disposed between each adjacent pair of wells 62 (e.g., see Example 3).

Bottom side 58 of the gasket may define at least one recess, such as a groove 148, for each sealing member 63. The recess may be sized and shaped according to rim 64 and/or a portion of side wall 108 adjacent the rim. The recess (such as groove 148) may receive at least a portion of rim 64 and/or a portion of side wall 108 that is adjacent rim 64. The recess/groove may be sized such that the gasket, at the groove, contacts inside wall region 144, an outside wall region 150, or both inside and outside wall regions 144, 150 of side wall 108. The groove may have a width, at a given position along the groove, that is about the same as, or less than, the thickness of side wall 108 at a corresponding position adjacent the rim, as measured between inside wall region 144 and outside wall region 150. With this dimensional relationship, the gasket may frictionally engage inside wall region 144 and/or outside wall region 150. In some cases, a top portion of side wall 108 may fit snugly in groove 148. Accordingly, the gasket may grip side wall 108 adjacent the rim by opposing engagement with inside wall region 144 and outside wall region 150, to attach the gasket to the well. Placement of rim 64 into the groove, when the gasket is being assembled with container 54, may deform the groove somewhat by urging the opposite side wall regions of the groove farther apart from each other. The gasket may have sufficient elasticity to provide a restoring force that urges the opposite side wall regions of the groove toward each other in this deformed configuration. Accordingly, the gasket assembled with container 54 at grooves 148 may attach the gasket removably to each of wells 62. For example, the gasket may be attached sufficiently that the gasket remains assembled with container 54 when the container is turned upside down.

Groove 148 may have various functions. The groove may promote sealing of the gasket to a well. The groove also may help to keep the gasket in place on container 54. The gasket may, in some cases, be installed on container 54 in the factory, such that the gasket and container are supplied to the user as pre-assembled unit. Accordingly, the groove may help to ensure that the gasket stays in place during shipping, handling, pipetting operations, etc.

Groove 148 may extend at least partially or completely around aperture 88 (and/or an axis 158 defined by the aperture). In the depicted embodiment, groove 148 follows a circular path and forms a closed loop. In other embodiments, groove 148 may be interrupted along its length or may be replaced by a plurality of grooves that each receive a different portion of the same rim. The plurality of grooves, collectively, may extend any suitable portion of the circumference of the well, such as a majority of the circumference. Groove 148 (or a plurality of shorter grooves collectively) may have a shape (e.g., circular, oval, polygonal (e.g., rectangular)) and/or follow a path that matches the shape of the rim of well 62. The gasket, in groove 148, may or may not have circumferential contact and/or frictional engagement with inside wall region 144, outside wall region 150, rim 64, or any combination thereof.

Top side 60 of gasket 52 may define one or more projections (raised surface features) that protrude upward, away from wells 62. The projections may help with sealing against interface member 74 and/or with gasket disengagement from the interface member. The projections may include a plurality of ridges 170, with each ridge extending completely around axis 158 (and/or completely around an axis that is orthogonal to a plane 172 defined by the gasket and that intersects opening 82).

FIG. 1 shows gasket 52 having a series of circular ridges 170, with one ridge per sealing member 63 and with the ridge centered over each well 62, around each aperture 88, and under each opening 82. Ridges 170 may be elastically deformable to facilitate forming a seal between gasket 52 and interface member 74 at each opening 82. Each ridge may elevate gasket-contacting surface 80 of the interface member from regions of the gasket's top side that are disposed radially outward and/or radially inward of the ridge (see FIG. 4).

Gasket 52 may define a recessed region 180 (e.g., a counterbore) above each aperture 88 (or set of two or more apertures), with the recessed region having a greater diameter than aperture(s) 88 (see FIG. 5). The recessed region may extend to a position below (to a lower elevation than) the base of each ridge 170. Ridges 170 and/or recessed regions 180 of the gasket may reduce the precision with which each sealing member 63 needs to be aligned with a corresponding opening(s) 82 of interface member 74, to form a circumferential seal with the interface member around the opening(s).

The gasket may have a wavy perimeter (see FIG. 6). For example, the gasket may have a pair of wavy longitudinal edges 182a, 182b arranged opposite each other. The edges may form a series of aligned, arcuate recesses 184 that extend, in pairs, centrally toward each other and arcuate protrusions 186 that extend laterally, away from one another. The presence of a wavy perimeter may allow the gasket to be manipulated more easily, such as when pressed onto wells 62 and/or disengaged from wells 62. The gasket may have any other suitable characteristics. The gasket may be formed of a resilient and/or elastic material, such as an elastomer, to facilitate forming a seal between the gasket and well 62 and/or interface member 74. Accordingly, the gasket may deform elastically when the gasket is placed onto well 62 and/or when the gasket is compressed between container 54 and interface member 74, to improve the extent of contact and/or to correct for misalignment and/or manufacturing tolerances. The gasket may be single-use or reusable. The gasket may be a separate piece that is assembled with the multi-well container by a user or may be supplied to the user as a pre-assembly unit. If supplied as a pre-assembled unit, the gasket may be fixed to the container, for example, with an adhesive or by bonding, to permanently attach the gasket to the container. In other examples, the gasket may be formed on (e.g., overmolded on) the container.

Further aspects of multi-well containers for droplet generation, pump assemblies to drive emulsion formation in multi-well containers, and gaskets are described in the patent documents listed above under Cross-References, particularly U.S. Patent Application Publication No. 2010/0173394 A1, published Jul. 8, 2010; U.S. Patent Application Publication No. 2012/0152369 A1, published Jun. 21, 2012; and U.S. Patent Application Publication No. 2012/0190032 A1, published Jul. 26, 2012, which are incorporated herein by reference.

### II. EXAMPLES

The following examples describe selected aspects and embodiments of the present disclosure related to fluid transport systems with a gasket. These examples are intended for illustration only and should not limit or define the entire scope of the present disclosure.

### Example 1

### Exemplary Gasket with Deformable Slit

This example describes an exemplary gasket 190 for use in droplet transport system 50 (e.g., see FIG. 1), with the gasket having a series of deformable slits 192, and methods of using the gasket for fluid transport; see FIGS. 7-10.

Each slit 192 may not prevent evaporation. Rather, the slit may reduce splashing from a well during emulsion formation, may provide an interface for a pipette tip to enter the well, and/or may be recessed away from the sealing surface with interface member 74, to minimize the alignment precision of the gasket to the well.

Gasket 190 has a series of sealing members 63 arranged along the gasket, with each sealing member configured for contact with a single well 62 and with interface member 74 around one or more of openings 82. Each sealing member 63 may define a plurality of apertures as smaller through-holes 194, relative to the single larger through-hole 88 of gasket 52 (e.g., compare FIGS. 6 and 7). Each through-hole 194 may be positioned to provide communication between a well 62 of container 54 and an opening 82 of interface member 74, when sealing member 63 is aligned with the well and opening 82, and is sandwiched between the well and the interface member. Through-holes 194 of a given sealing member 63 may be present in any suitable arrangement, such as circular (as shown here), elliptical, or arbitrary, among others. With multiple through-holes per sealing member 63, if fluid is splashed up onto the gasket surface (and into one of the through-holes), air flow (caused by a pressure differential) can redirect itself to unobstructed through-holes of the sealing member. As a result, the splashed fluid is not pulled through the gasket and into/onto the manifold, as may occur with a single through-hole per sealing member 63.

Each slit 192 may have any suitable structure. The slit may be a through-hole that extends through the gasket, from the top side to the bottom side of the gasket. The slit may or may not communicate with one or more through-holes 194. For example, in the depicted embodiment, slit 192 extends to a pair of through-holes 194. In other examples, the slit may extend to only one through-hole or may be spaced from all of the through-holes, among others.

The slit may have facing lateral walls with any suitable separation from each other. In some embodiments, the lateral walls may contact each, before and/or after sealing member 63 is operatively disposed between interface member 74 and well 62. In some embodiments, the lateral walls may be separated from each other by a gap only before, or both before and after the sealing member is operatively disposed. The slit may not (or may) provide a vapor barrier.

FIGS. 9 and 10 show how slit 192 may allow an end of a fluid transfer tip 196 (e.g., an end of a conduit, such as a pipette tip) to pass through the slit to the underlying well. The slit may be resiliently expandable. In particular, the slit may be deformed to a more open configuration by inserting a leading region of tip 196 through the slit. The tip maybe used to withdraw (or add) fluid, such as at least a portion of emulsion 134 as shown. Slit 192 may be self-closing when the tip is removed (i.e., the slit may return to the configuration of FIG. 9 from that of FIG. 10 when tip 196 is removed).

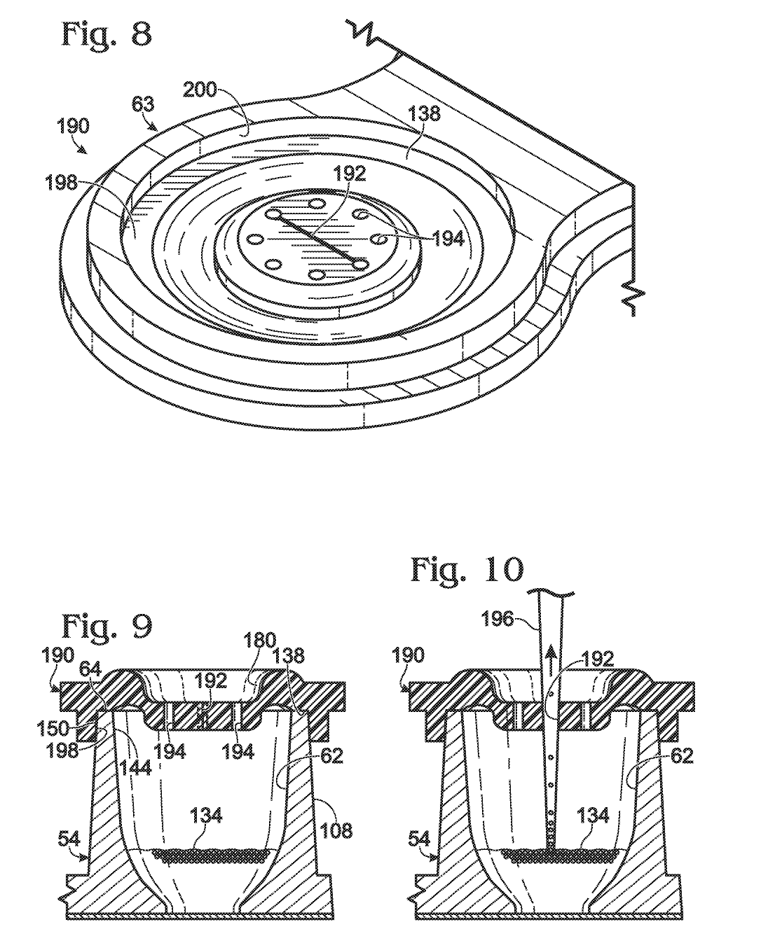

Each sealing member 63 may define a recess 198 on the bottom side of the gasket (see FIG. 9). Rim 64 of the well may circumferentially contact a ceiling region of the recess. Also, recess 198 may be configured to provide frictional engagement between outside wall region 150 of side wall 108 and a perimeter wall 200 of the recess (see FIGS. 8 and 9). Recess 198 may have a diameter that is about the same as, or slightly less than the outer diameter of side wall 108 adjacent rim 64, to encourage frictional engagement. In some cases, the frictional engagement may attach the sealing member to the well. The sealing member may circumferentially contact outer wall region 150 at perimeter wall 200 of the recess, to help promote sealing of the gasket to the well. In the depicted embodiment, the sealing member does not contact inner wall region 144 of side wall 108.

### Example 2

### Exemplary Interface Member with Surface Features

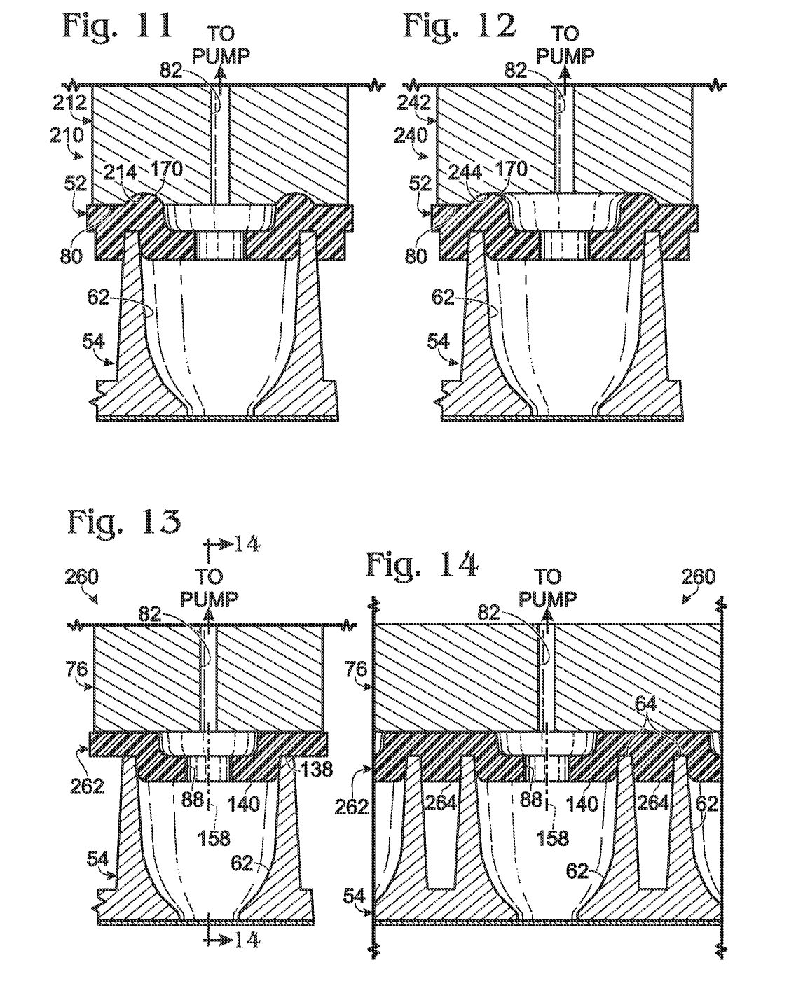

This example describes exemplary interface members having a gasket-contacting region with recessed features to receive at least a portion of a gasket; see FIGS. 11 and 12. The fluid transport systems described in this Example may include any suitable combination of the devices and features described elsewhere in the present disclosure, such as is Section I and in Examples 1 and 3.

FIG. 11 shows a fragmentary sectional view of an exemplary fluid transport system 210 including a manifold 212 that defines a series of grooves 214 (interchangeably termed channels). (Only one groove 214 is visible in FIG. 11.) Each groove 214 is defined by gasket-contacting side 80. Individual grooves 214 may be alignable with individual ridges 170 formed on a top side of gasket 52 (e.g., also see FIGS. 1 and 5). Each groove 214 may be configured to receive at least a circumferential portion of one of ridges 170.

FIG. 12 shows a fragmentary sectional view of an exemplary fluid transport system 240 including a manifold 242 defining a series of recesses 244 on gasket-contacting side 80 (only one recess 244 is visible in FIG. 12). Recesses 244 may be aligned with ridges 170 formed on a top side of gasket 52 (e.g., see FIGS. 1 and 5). Manifold 242 may define a distinct recess 244 to receive at least a circumferential portion of each ridge 170.

### Example 3

### Gasket with a Series of Between-well Projections

This example describes an exemplary fluid transport system 260 including a gasket 262 having distinct projections 264 disposed between plug members 140; see FIGS. 13 and 14.

Each projection 264 may extend below each rim 64 of a pair of adjacent wells 62, with the projection disposed at least partially between the pair of wells (see FIG. 14). The projection may extend only partially around axis 158 defined by aperture 88, such as less than about one-half or one-fourth of a complete circle. Accordingly, projections 264 are not visible in FIG. 13, either to the left or the right of well 62. One or more of wells 62 may be opposingly flanked by projections 264, which may be spaced from each other in a direction at least generally parallel to a long axis defined by the gasket.

### Example 4

### Further Aspects of Fluid Transport Systems

This example describes an exemplary unimproved gasket of the prior art and exemplary aspects of the fluid transport systems disclosed herein.

An exemplary, unimproved gasket may be formed of a flat gasketing material with a durometer (hardness) in the range of Shore 40 A to Shore 80 A and may be approximately 0.01 to 0.06 inches thick. With this arrangement, the gasket may require two opposing optimizations: reducing the size of the through-holes in the gasket that are aligned with wells, to prevent splashing onto the manifold, and maximizing the size of each through-hole to ease the positioning requirement of the gasket with respect to the manifold.

The unimproved gasket may not be physically pinned to individual wells but rather may be held in place by pins that are several millimeters away from the wells; thus, the gasket can move and/or be pushed around by the user, the multi-well container, or the manifold, among others. This gasket movement can lead to unexpected failures (e.g., no droplets generated, pushback irregularities, or reduced droplet counts). In addition, the unimproved gasket may be sensitive to material variations in the extruded silicone film that forms the gasket.

The present disclosure may address one or more of these issues with a molded gasket (e.g., cast, liquid injection-molded, or injection-molded) that may (or may not) have a combination of the following design features. (1) A flat sealing surface region formed by the bottom or underside of the gasket for sealing the gasket to the top of each well (e.g., covering and/or engaging the top surface region of all wells or all output wells, among others). (2) Features (e.g., protrusions) projecting downward from the flat sealing surface region to provide alignment of the gasket with the multi-well container, and, optionally, to restrict lateral/longitudinal slippage of the gasket. The protrusions may be received at least partially in individual wells and/or between wells, among others. In some cases, each protrusion may have a diameter that corresponds to the inner diameter of a well in which the protrusion is received. (3) Recesses may be formed in the top surface of the gasket, with each recess producing a larger area for aligning the gasket with the manifold, while relaxing the accuracy with which the container must be aligned with the manifold. (4) A smaller diameter through-hole may extend downward from each recess to the underside of the gasket, which may reduce “splashing” while allowing fluid (air) communication between the manifold and wells of the container.

The gaskets of the present disclosure may provide various benefits besides those described elsewhere herein, such as improved control over material durometer, material thickness, and part cleanliness.

The present disclosure may provide a droplet generation system utilizing a novel approach to gasketing a multi-well container to form emulsions. The system may isolate sample/emulsion from a manifold to prevent contamination. The system also may seal wells of the container to the manifold for operation under suction or pressure. The system may prevent “splashing” of the emulsions from the output wells onto the manifold. Depending on the application, the ability to pass a pipette tip through the gasket may or may not be required. For example, a user may manually remove the gasket after emulsion formation before placing a pipette tip in a well. In other cases, such as with automated droplet generators, it may be desirable to leave the gasket in place (e.g., such that emulsions are aspirated from wells through the gasket).

### Example 5

### Selected Embodiments

This example describes additional selected embodiments of a fluid transport system with a gasket. The selected embodiments are presented as a series of numbered paragraphs.

1. A system for fluid transport, comprising: (A) a plurality of wells each having a rim; and (B) a gasket defining a plurality of apertures that extend through the gasket from a top side to a bottom side of the gasket, the bottom side defining a plurality of grooves with each groove extending at least partway around an axis defined by an aperture of the plurality of apertures, the gasket being configured to have the top side of the gasket engaged with a pump assembly and at least a portion of the rim of each of the wells disposed in at least one groove of the plurality of grooves, to provide sealed communication between the pump assembly and each of the wells.

2. The system of paragraph 1, wherein each groove of the plurality of grooves extends completely around an axis defined by an aperture of the plurality of apertures.

3. The system of paragraph 1 or 2, wherein each groove of the plurality of grooves extends around two or more axes defined by two or more of the plurality of apertures.

4. The system of paragraph 1 or 2, wherein each groove of the plurality of grooves extends around only one axis defined by only one aperture that extends through the gasket from the top side to the bottom side.

5. The system of paragraph 4, wherein the top side of the gasket defines a plurality of recesses, with each recess overlapping an aperture of the plurality of apertures such that the aperture that is overlapped widens toward the top side.

6. The system of any of paragraphs 1 to 5, wherein the top side of the gasket defines a plurality of ridges, and wherein each ridge surrounds an axis defined by an aperture of the plurality of apertures.

7. The system of any of paragraphs 1 to 6, further comprising a pump assembly configured to be engaged with the top side of the gasket.

8. The system of paragraph 7, wherein the pump assembly includes a manifold defining a plurality of openings, and wherein the top side of the gasket is configured to be engaged with the manifold such that each ridge contacts a respective surface region of the manifold that extends circumferentially around an opening of the plurality of openings.

9. The system of any of paragraphs 1 to 8, wherein the gasket is configured to frictionally engage each well of the plurality of wells at one or more of the plurality of grooves to attach the gasket to each well of the plurality of wells.

10. The system of any of paragraphs 1 to 9, wherein each well has a side wall forming the rim and also forming an inside wall region and an outside wall region, and wherein the gasket is configured to frictionally engage the inside wall region, the outside wall region, or both the inside wall region and the outside wall region.

11. The system of paragraph 10, wherein the gasket is configured to frictionally engage the inside wall region and the outside wall region.

12. The system of paragraph 10 or 11, wherein the gasket is configured to circumferentially contact the inside wall region of each well of the plurality of wells.

13. The system of any of paragraphs 10 to 12, wherein the gasket is configured to circumferentially contact the outside wall region of each well of the plurality of wells.

14. The system of paragraph 13, wherein the gasket is configured to circumferentially contact the inside wall region of each well of the plurality of wells.

15. The system of any of paragraphs 1 to 14, wherein the plurality of wells is a first plurality of wells formed by a container that also forms a second plurality of wells that are not engaged with the gasket when the gasket provides the sealed communication, wherein the container defines a plurality of channels that collectively provide communication between each well of the first plurality of wells and at least one well of the second plurality of wells, and wherein the plurality of channels form a respective droplet generation site for each well of the first plurality of wells.

16. The system of any of paragraphs 1 to 15, wherein each well of the plurality of wells defines an axis and has a side wall surrounding the axis defined by the well, and wherein the gasket is configured to grip a portion of the side wall to retain the gasket on the well.

17. The system of paragraph 16, wherein the gasket is configured to grip the portion of the side wall by frictional engagement of an inside wall region and an outside wall region of the side wall adjacent the rim.

18. The system of any of paragraphs 1 to 17, further comprising a pump assembly having a manifold defining a plurality of openings for alignment with the plurality of wells.

19. The system of paragraph 18, wherein the manifold has a planar surface region that defines the plurality of openings.

20. The system of any of paragraphs 1 to 19, wherein the gasket is formed of an elastomer.

21. The system of any of paragraphs 1 to 20, wherein each groove extends at least partway around a slit defined by the gasket.

22. The system of any of paragraphs 1 to 21, wherein the gasket defines a long axis and has a pair of wavy lateral edges that opposing flank the long axis.

23. The system of any of paragraphs 1 to 22, wherein the gasket defines a plane and has a perimeter lip that projects parallel to the plane.

24. The system of any of paragraphs 1 to 23, wherein the plurality of wells is a first plurality of wells defined by a container that also defines a second plurality of wells that are not covered by the gasket when the gasket provides the sealed communication.

25. The system of paragraph 24, wherein the container defines a plurality of channels that collectively provide communication between each well of the first plurality of wells and at least one well of the second plurality of wells.

26. The system of paragraph 25, wherein the plurality of channels form a respective droplet generation site for each of the wells of the first plurality of wells.

27. A system for fluid transport, comprising: (A) a plurality of wells each having a side wall forming a rim; (B) a pump assembly; and (C) a gasket configured to provide sealed communication between the pump assembly and each of the wells, the gasket defining a plurality of apertures that extend through the gasket from a top side for engagement of the pump assembly to a bottom side defining a plurality of grooves, a portion of the side wall below the rim of each of the wells being disposed in a groove of the plurality of grooves and being frictionally engaged by the gasket at the groove.

28. The system of paragraph 27, wherein the side wall includes an inside wall region and an outside wall region, and wherein the portion of the side wall is gripped by frictional engagement of the gasket with the inside wall region and the outside wall region at the groove.

29. The system of paragraph 27 or 28, wherein the side wall has a thickness measured between an inside wall region and an outside wall region adjacent the rim, and wherein the groove has a width that is about the same as, or less than, the thickness of the side wall before the portion of the side wall is disposed in the groove.

30. The system of any of paragraphs 27 to 30, wherein the top side of the gasket defines a plurality of ridges, and wherein each ridge surrounds an axis defined by an aperture of the plurality of apertures.

31. A method of transporting fluid, the method comprising: (A) providing a container assembled with a gasket that defines a plurality of grooves, the container forming a set of wells each having a rim that is at least partially disposed in a groove of the plurality of grooves; (B) creating, via the gasket, sealed communication between a manifold and each well of the set of wells; and (C) operating a pump that is operatively connected to the manifold, to move fluid into and/or out of each well of the set of wells.

32. The method of paragraph 31, wherein the step of operating a pump forms a plurality of emulsions and drives at least a portion of an emulsion of the plurality of emulsions into each well of the set of wells via a port of the well that is spaced from the rim.

33. The method of paragraph 31 or 32, further comprising a step of placing an end of a fluid transfer tip through the gasket and into a well of the set of wells, and a step of moving fluid into and/or out of the well via the fluid transfer tip while the gasket remains assembled with the container.

34. The method of paragraph 33, wherein the step of moving fluid includes a step of withdrawing at least a portion of an emulsion formed by the step of operating a pump.

35. The method of paragraph 33 or 34, wherein the gasket defines a slit, and wherein the step of placing an end of a fluid transfer tip expands the slit.

36. The method of paragraph 35, further comprising a step of removing the fluid transfer tip from the well, wherein the slit returns to a more closed configuration after the fluid transfer tip is removed.

37. The method of paragraph 33, wherein the step of moving fluid includes a step of moving fluid through an aperture defined by the gasket, and wherein the step of placing an end of a fluid transfer tip and the step of moving fluid are performed without temporarily or permanently changing a shape of the aperture.

38. The method of any of paragraphs 31 to 37, wherein the step of operating a pump includes a step of applying pressure that drives a prospective phase of an emulsion from each well of the set of wells to a site of droplet generation at which the prospective phase forms a continuous phase or a dispersed phase of the emulsion.

39. A method of transporting fluid, the method comprising: (A) providing a gasket disposed between and in contact with an interface member and a set of wells, with a rim of each well of the set of wells being at least partially disposed in one or more grooves defined by the gasket, to create sealed communication between openings of the interface member and each well of the set of wells; and (B) applying suction and/or pressure to each well of the set of wells via the interface member to move fluid into and/or out of each well of the set of wells.

40. The method of paragraph 39, wherein the interface member is a manifold having a surface region defining the openings, wherein the manifold defines channels that place the openings in communication with one another, and wherein the gasket contacts the surface region of the manifold circumferentially around each of the openings.

41. The method of paragraph 39 or 40, wherein the step of applying suction and/or pressure includes a step of applying suction that causes formation of a distinct emulsion for each well of the set of wells.

42. The method of paragraph 41, wherein the step of applying suction drives at least a portion of each emulsion into a well of the set of wells via a port of the well that is spaced from the rim.

43. The method of any of paragraphs 39 to 42, wherein the step of applying suction and/or pressure includes a step of applying pressure that drives a prospective phase of an emulsion from each well of the set of wells to a site of droplet generation at which the prospective phase forms a continuous phase or a dispersed phase of the emulsion.

44. The method of any of paragraphs 39 to 43, further comprising a step of placing an end of a conduit through the gasket and into a well of the set of wells, and a step of withdrawing fluid from the well via the conduit.

45. The method of paragraph 44, wherein the step of withdrawing fluid includes a step of withdrawing at least a portion of an emulsion formed by the step of applying suction and/or pressure.

46. The method of paragraph 44 or 45, wherein the gasket defines a slit, and wherein the step of placing an end of the conduit expands the slit.

47. The method of paragraph 46, further comprising a step of removing the end of the conduit from the well, wherein the slit returns to a more closed configuration after the end of the conduit is removed.

48. A system for fluid transport, comprising: (A) a container including a plurality of wells each having a rim; (B) a pump assembly including a pump operatively connected to a manifold; and (C) a gasket having a top side opposite a bottom side and defining a plurality of apertures that extend through the gasket from the top side to the bottom side, the bottom side defining a plurality of plug members corresponding to the plurality of wells, each plug member being perforated by at least one of the apertures and having a diameter corresponding to an inside diameter of one of the wells adjacent the rim, the gasket being positioned or positionable such that the top side is engaged with the manifold and each of the plug members is disposed in a well, to provide sealed communication between the pump assembly and each of the wells.

49. A system for fluid transport, comprising: (A) a plurality of wells each having a rim; (B) a pump assembly including a pump operatively connected to a manifold; and (C) a gasket having a top side opposite a bottom side and defining a plurality of through-holes that extend through the gasket from the top side to the bottom side, the bottom side having a plurality of sealing members corresponding to the plurality of wells, each sealing member defining at least one of the through-holes, being in circumferential contact with the rim of one of the wells, and projecting into the one well for circumferential contact with an inside wall region of the one well, to provide sealed communication between the pump assembly and each of the plurality of wells.

50. A system for fluid transport, comprising: (A) a plurality of wells each having a rim; (B) a pump assembly including a pump operatively connected to a manifold; and (C) a gasket having a top side opposite a bottom side and defining a plurality of through-holes that extend through the gasket from the top side to the bottom side, the bottom side defining a plurality of recesses corresponding to the plurality of wells, each recess overlapping at least one of the through-holes and having a diameter corresponding an outside diameter of one of the wells adjacent the rim, the gasket being positioned or positionable such that the top side is engaged with the manifold and the rim of each of the plurality of wells is disposed in one of the recesses for circumferential contact of an outside wall region of the well with the gasket, to provide sealed communication between the pump assembly and each of the plurality of wells.

51. A system for fluid transport, comprising: (A) a plurality of wells each having a rim; and (B) a gasket defining a plurality of apertures that extend through the gasket from a top side to a bottom side of the gasket, the bottom side defining a plurality of grooves with each groove extending around an axis defined by an aperture, the gasket being positioned or positionable such that the top side is engaged with a pump assembly and such that at least a portion of the rim of each of the wells is disposed in at least one of grooves, to provide sealed communication between the pump assembly and each of the wells.

52. A system for fluid transport, comprising: (A) a plurality of wells each having a rim; (B) a pump assembly; and (C) a gasket defining a plurality of apertures that extend through the gasket from a first side to a second side opposite the first side, the first side defining a plurality of grooves, with each groove surrounding at least one axis defined by at least one of the apertures, the gasket being positioned or positionable such that the second side is engaged with the pump assembly, with the rim of each of the wells disposed in one of the grooves, to provide sealed communication between the pump assembly and each of the wells.

53. A system for fluid transport, comprising: (A) a plurality of wells each having a rim; (B) a pump assembly; and (C) a gasket having a plurality of integral sealing members, each sealing member having a first side opposite a second side and defining one or more apertures that extend through the sealing member, the first side defining a groove surrounding at least one axis defined by the one or more apertures, the gasket being positionable such that the second side of each sealing member is engaged with the pump assembly, with the rim of a well disposed in the groove of the sealing member, to provide sealed communication between the pump assembly and each of the wells.

54. A system for fluid transport, comprising: (A) a plurality of wells each having a side wall forming a rim; (B) a pump assembly; and (C) a gasket configured to provide sealed communication between the pump assembly and each of the wells, the gasket defining a plurality of apertures that extend through the gasket from a top side of the gasket for engagement of the pump assembly to a bottom side of the gasket that defines a plurality of protrusions, a portion of the side wall below the rim of each of the wells being engaged with one or more of the protrusions.

55. The system of paragraph 54, wherein the bottom side forms a sealing surface region adjacent the one or more protrusions to seal each of the wells to the gasket.

56. The system of paragraph 55, wherein the sealing surface region is planar.

57. The system of paragraph 54, wherein engagement of the one or more protrusions with the portion of the side wall attaches the gasket to each well of the plurality of wells.

The disclosure set forth above may encompass multiple distinct inventions with independent utility. Although each of these inventions has been disclosed in its preferred form(s), the specific embodiments thereof as disclosed and illustrated herein are not to be considered in a limiting sense, because numerous variations are possible. The subject matter of the inventions includes all novel and nonobvious combinations and subcombinations of the various elements, features, functions, and/or properties disclosed herein. The following claims particularly point out certain combinations and subcombinations regarded as novel and nonobvious. Inventions embodied in other combinations and subcombinations of features, functions, elements, and/or properties may be claimed in applications claiming priority from this or a related application. Such claims, whether directed to a different invention or to the same invention, and whether broader, narrower, equal, or different in scope to the original claims, also are regarded as included within the subject matter of the inventions of the present disclosure. Further, ordinal indicators, such as first, second, or third, for identified elements are used to distinguish between the elements, and do not indicate a particular position or order of such elements, unless otherwise specifically stated.

We claim:

1. A system for fluid transport, comprising:
a plurality of wells each having a rim; and
a gasket defining a plurality of apertures that extend through the gasket from a top side to a bottom side of the gasket, the bottom side defining a plurality of grooves with each groove extending at least partway around an axis defined by an aperture of the plurality of apertures, the gasket being configured to have the top side of the gasket engaged with a pump assembly and at least a portion of the rim of each of the wells disposed in at least one groove of the plurality of grooves, to provide sealed communication between the pump assembly and each of the wells.

2. The system of claim 1, wherein each groove of the plurality of grooves extends completely around an axis defined by an aperture of the plurality of apertures.

3. The system of claim 1, wherein each groove of the plurality of grooves extends around two or more axes defined by two or more apertures of the plurality of apertures.

4. The system of claim 1, wherein each groove of the plurality of grooves extends around only one axis defined by only one aperture that extends through the gasket from the top side to the bottom side.

5. The system of claim 4, wherein the top side of the gasket defines a plurality of recesses, with each recess overlapping an aperture of the plurality of apertures such that the aperture that is overlapped widens toward the top side.

6. The system of claim 1, wherein the top side of the gasket defines a plurality of ridges, and wherein each ridge surrounds an axis defined by an aperture of the plurality of apertures.

7. The system of claim 1, further comprising a pump assembly configured to be engaged with the top side of the gasket.

8. The system of claim 1, wherein the gasket is configured to frictionally engage each well of the plurality of wells at one or more of the plurality of grooves to attach the gasket to each well of the plurality of wells.

9. The system of claim 1, wherein each well has a side wall forming the rim and also forming an inside wall region and an outside wall region, and wherein the gasket is configured to frictionally engage the inside wall region, the outside wall region, or the inside wall region and the outside wall region.

10. A system for fluid transport, comprising:
a plurality of wells each having a side wall forming a rim;
a pump assembly; and
a gasket configured to provide sealed communication between the pump assembly and each of the wells, the gasket defining a plurality of apertures that extend through the gasket from a top side for engagement of the pump assembly to a bottom side defining a plurality of grooves, a portion of the side wall below the rim of each of the wells being disposed in a groove of the plurality of grooves and being frictionally engaged by the gasket at the groove.

11. The system of claim 10, wherein the side wall includes an inside wall region and an outside wall region, and wherein the portion of the side wall is gripped by frictional engagement of the gasket with the inside wall region and the outside wall region at the groove.

12. The system of claim 10, wherein the side wall has a thickness measured between an inside wall region and an outside wall region adjacent the rim, and wherein the groove has a width that is about the same as, or less than, the thickness of the side wall before the portion of the side wall is disposed in the groove.

13. The system of claim 10, wherein the top side of the gasket defines a plurality of ridges, and wherein each ridge surrounds an axis defined by an aperture of the plurality of apertures.

14. A method of transporting fluid, the method comprising:
providing a container assembled with a gasket that defines a plurality of grooves, the container forming a set of wells each having a rim that is at least partially disposed in a groove of the plurality of grooves;
creating, via the gasket, sealed communication between a manifold and each well of the set of wells; and
operating a pump that is connected to the manifold, to move fluid into and/or out of each well of the set of wells.

15. The method of claim 14, wherein the step of operating a pump forms a plurality of emulsions and drives at least a portion of an emulsion of the plurality of emulsions into each well of the set of wells via a port of the well that is spaced from the rim.

16. The method of claim 14, further comprising a step of placing an end of a fluid transfer tip through the gasket and into a well of the set of wells, and a step of moving fluid into and/or out of the well via the fluid transfer tip while the gasket remains assembled with the container.

17. The method of claim 16, wherein the step of moving fluid includes a step of withdrawing at least a portion of an emulsion formed by the step of operating a pump.

18. The method of claim 16, wherein the gasket defines a slit, and wherein the step of placing an end of a fluid transfer tip expands the slit.

19. The method of claim 18, further comprising a step of removing the fluid transfer tip from the well, wherein the slit returns to a more closed configuration after the fluid transfer tip is removed.

20. The method of claim 16, wherein the step of moving fluid includes a step of moving fluid through an aperture defined by the gasket, and wherein the step of placing an end of a fluid transfer tip and the step of moving fluid are performed without temporarily or permanently changing a shape of the aperture.
